(19) United States
(12) Patent Application Publication
(10) Pub. No.: US 2026/0078954 A1
(43) Pub. Date: Mar. 19, 2026

(54) APPARATUS FOR DRYING ELECTRODE

(71) Applicant: SAMSUNG SDI CO., LTD., Yongin-si (KR)

(72) Inventors: Hansol LEE, Yongin-si (KR); Kyeongho JANG, Yongin-si (KR); Yeyeong HWANG, Yongin-si (KR); Hyejin AHN, Yongin-si (KR)

(21) Appl. No.: 19/173,935

(22) Filed: Apr. 9, 2025

(30) Foreign Application Priority Data
Sep. 13, 2024 (KR) 10-2024-0126050

(51) Int. Cl. F26B 13/30; F26B 21/00

(52) U.S. Cl. CPC F26B 13/30; F26B 21/50

(57) ABSTRACT

An apparatus for drying an electrode may include a drying part configured to be positioned above a moving electrode plate and to direct gas in a direction opposite to a moving direction of the electrode plate to dry a slurry formed on a substrate of the electrode plate. and the drying part may also be configured to suck gas that has been used to dry the slurry. A gas supply part configured to supply the gas to the drying part, and an exhaust part configured to discharge the gas sucked into the drying part to outside of the apparatus.

The present application claims priority to and the benefit of Korean Application No. 10-2024-0126050, filed on September 13, 2024, in the Korean Intellectual Property Office, the entire disclosure of which is incorporated by reference herein.

### SUMMARY OF INVENTION

### BACKGROUND

### Field

Aspects of embodiments of the present disclosure relate to an apparatus for drying an electrode.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Secondary batteries are manufactured using various types of processes. In a process for manufacturing an electrode process for a secondary battery, a slurry including an active material is coated on a substrate and then dried to make a positive electrode or a negative electrode of a secondary battery. In general, the slurry coated on the substrate is dried as a solvent forming a part of the slurry evaporates while slurry coated substrate is passing through a drying device.

If the slurry dries, the quality of the secondary battery may be deteriorated due to migration of a binder in the slurry.

The above information disclosed in this Background section is for enhancement of understanding of the background of the present disclosure, and therefore it may contain information that does not constitute related (or prior) art.

### SUMMARY

Aspects of embodiments of the present disclosure provide an apparatus for drying an electrode.

These and other aspects and features of the present disclosure will be described in or will be apparent from the following description of embodiments of the present disclosure.

According to one or more embodiments of the present disclosure, an apparatus is provided for drying an electrode, and the apparatus may include a drying part configured (i) to be positioned above a moving electrode plate, (ii) to direct a gas in a direction opposite to a moving direction of the electrode plate to dry a slurry formed on a substrate of the electrode plate, and (iii) to suck gas that has been used to dry the slurry, an gas supply part configured to supply the gas to the drying part, and an exhaust part configured to discharge the gas sucked into the drying part to outside of the apparatus.

In some embodiments, the drying part may include a housing positioned above the electrode plate and including an air supply chamber and an exhaust chamber, a gas supply nozzle passing through a lower surface of the housing, in fluid communication with the air supply chamber, and configured to direct the gas in a width direction of the electrode plate, and an exhaust nozzle passing through the lower surface of the housing, in fluid communication with the exhaust chamber, and configured to suck in gas that has been used to dry the slurry.

In some embodiments, the gas supply nozzle may be positioned downstream with respect to the moving direction of the electrode plate, and the exhaust nozzle may be positioned upstream with respect to the moving direction of the electrode plate and facing the gas supply nozzle.

In some embodiments, the gas supply nozzle and the exhaust nozzle may be formed in an elongated slit shape along a width direction of the electrode plate and are longer than a width of the electrode plate.

In some embodiments, the gas supply nozzle may be positioned at an acute angle with respect to the moving direction of the electrode plate.

In some embodiments, the exhaust nozzle may be positioned at an obtuse angle with respect to the moving direction of the electrode plate.

In some embodiments, the drying part may include a gas supply connection part protruding from an upper surface of the housing, with the gas supply connection part being joined to the gas supply part and in fluid communication with the gas supply chamber, and an exhaust connection part protruding from the upper surface of the housing, with the exhaust connection part being joined to the exhaust part and in fluid communication with the exhaust chamber.

In some embodiments, the gas connection part may protrude from the upper surface of the housing in a central portion of the housing and have a width that is less than a width of the air supply chamber.

In some embodiments, the exhaust connection part may be configured to protrude from ends of the housing and have a width that is less than a width of the exhaust chamber.

In some embodiments, the gas supply connection part and the exhaust connection part do not overlap each other in the moving direction of the electrode plate.

In some embodiments, the width of the gas supply connection part may be greater than the width of the exhaust connection part.

In some embodiments, a width of the gas supply nozzle may be equal to the width of the gas supply connection part.

In some embodiments, a width of the exhaust nozzle may be equal to the width of the exhaust connection part.

In some embodiments, the drying part may further include a gas supply perforation plate provided in at least one of the air supply connection part and the air supply chamber, and the gas supply perforation plate having a plurality of through holes through which the gas used to dry the slurry can flow.

In some embodiments, the drying part may further include an gas supply perforation plate provided in at least one of the exhaust connection part and the exhaust chamber, the gas supply perforation plate having a plurality of through holes through which the gas used to dry the slurry can flow.

In some embodiments, the gas supply part may include a gas air generation part configured to generate the gas, and an exhaust duct configured to connect the gas generation part and the gas supply connection part, the exhaust duct being configured to supply the gas.

In some embodiments, the exhaust part may include an exhaust duct connected to the exhaust connection part and into which the gas used to dry the slurry may be introduced, and a gas exhaust part connected to the exhaust duct and configured to force gas to be discharged to outside of the apparatus.

In some embodiments, the exhaust duct may include a first exhaust duct connected to an exhaust connection part formed at a first end of the housing, and a second exhaust duct connected to an exhaust connection part formed at a second end of the housing.

In some embodiments, the exhaust duct may further include an exhaust duct connection part configured to connect the first exhaust duct and the second exhaust duct.

In some embodiments, the drying part may be provided in plurality along the moving direction of the electrode plate.

According to some embodiments of the present disclosure, gas (hot air) may be uniformly supplied in the width direction of the electrode to uniformly dry the slurry coated on the substrate in the width direction.

However, aspects and features of the present disclosure are not limited to those described above, and other aspects and features not mentioned will be clearly understood by a person skilled in the art from the detailed description, described below.

### BRIEF DESCRIPTION OF DRAWINGS

The drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a side view of an apparatus for drying an electrode according to some embodiments of the present disclosure.

FIG. 2 is a perspective view of a drying part in the apparatus for dying an electrode according to some embodiments of the present disclosure.

FIG. 3 is a cross-sectional view of a region A-A of FIG. 2.

FIG. 4 is a cross-sectional view in which an electrode is dried by the drying part according to some embodiments of the present disclosure.

FIG. 5 is a side view of an apparatus for drying an electrode according to other embodiments of the present disclosure.

FIG. 6 is a view of the apparatus for drying an electrode according to other embodiments of the present disclosure.

FIG. 7 is a partial front view of an exhaust part in the apparatus for drying an electrode according to other embodiments of the present disclosure.

FIG. 8 is a perspective view of a drying part in the apparatus for drying an electrode according to other embodiments of the present disclosure.

FIG. 9 is a cross-sectional view of region B-B of FIG. 8.

FIG. 10 is a cross-sectional view of region C-C of FIG. 9.

FIG. 11 is a cross-sectional view of region D-D of FIG. 9.

FIG. 12 is a cross-sectional view of region E-E of FIG. 8.

FIG. 13 is a cross-sectional view of region F-F of FIG. 8.

FIG. 14 is a bottom view of the drying part positioned above the electrode according to other embodiments of the present disclosure.

FIG. 15 is an example of a state in which gas flows through the drying part according to other embodiments of the present disclosure.

FIG. 16 is another example of a nozzle in a drying part according to other embodiments of the present disclosure.

FIG. 17 is an example of a state in which gas flows through the nozzle of FIG. 16.

FIG. 18 s a cross-sectional view of a drying part having a perforation plate according to other embodiments of the present disclosure.

FIG. 19 is a cross-sectional view of region G-G of FIG. 18.

FIGS. 20 and 21 are cross-sectional views of an air supply perforation plate positioned by cutting region H-H of FIG. 19.

FIG. 22 is a plan view in which the drying part dries four rows of slurry formed on a substrate according to other embodiments of the present disclosure.

FIG. 23 is a graph comparing the adhesive strength of four rows of slurry layers dried by the drying part according to other embodiments of the present disclosure.

FIG. 24 is a graph comparing the density of four rows of slurry layers dried by the drying part according to other embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

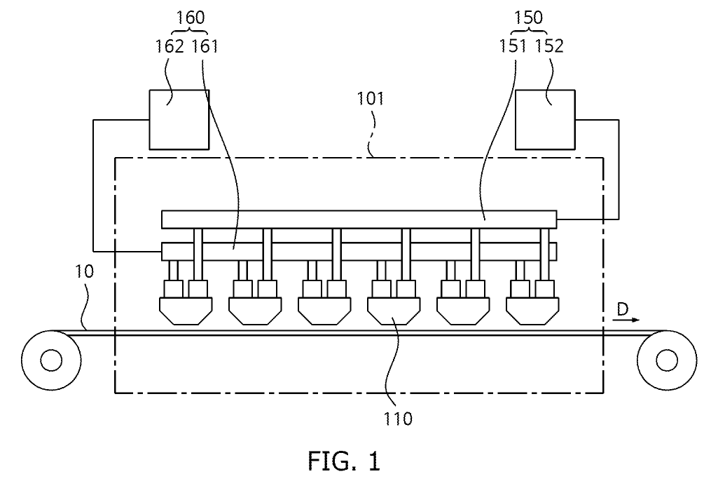

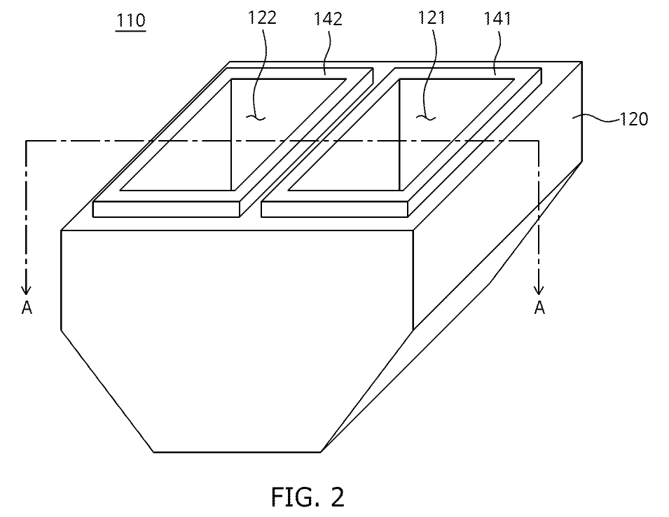

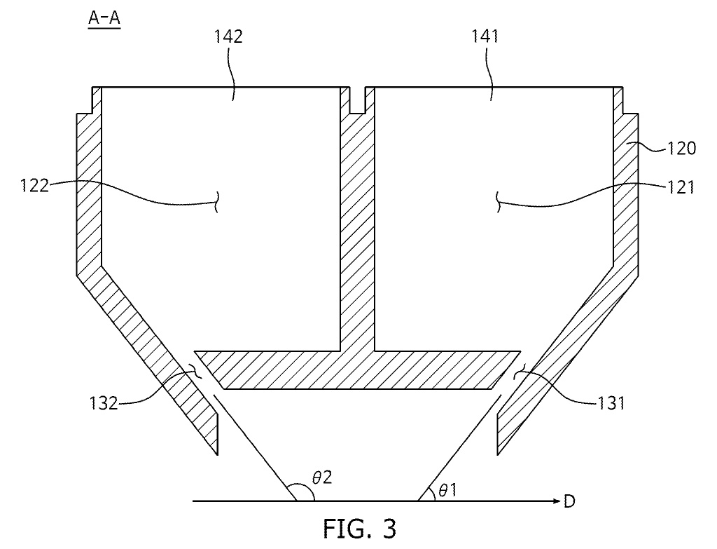

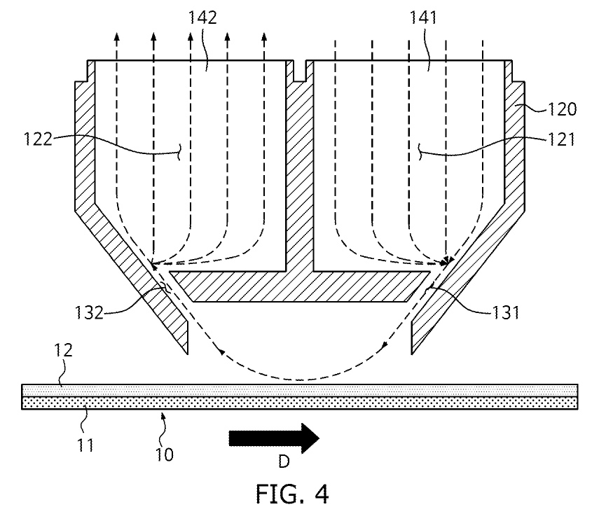

FIG. 1 is a side view of an apparatus for drying an electrode according to some embodiments of the present disclosure, FIG. 2 is a perspective view showing an example of a drying part in the apparatus for dying an electrode according to some embodiments of the present disclosure, FIG. 3 is a cross-sectional view showing an example of a region A-A of FIGS. 2, and 4 is a cross-sectional view showing an example in which an electrode is dried by the drying part according to some embodiments of the present disclosure.

Referring to FIGS. 1 to 4, an apparatus 100 for drying an electrode according to some embodiments of the present disclosure may include a drying part 110 that sprays hot air onto a moving electrode plate 10 to dry a slurry 12 that is applied onto a substrate 11. The apparatus 100 may also include an air supply part 150 that supplies the hot air to the drying part 110, and an exhaust part 160 that discharges gas sucked into the drying part 110 to outside of the apparatus. The hot air may be high-temperature gas for drying the slurry.

The drying part 110 may be positioned above the moving electrode plate 10 and may spray the hot air in a direction that is opposite to the moving direction D of the electrode plate 10 so as to dry the slurry 12 on the substrate 11. The drying part 110 may suck in the gas that has contacted and dried the slurry 12 and discharge the gas to outside of the apparatus. That is, the drying part 110 may be configured to suck the gas that has been used to dry the slurry 12 while spraying new gas (e.g., hot air) towards the moving electrode plate 10.

In some embodiments, the drying part 110 may include a housing 120 positioned above the electrode plate 10 and including an air supply chamber 121 and an exhaust chamber 122. The air supply and exhaust chambers 121 and 122 may be formed by dividing the interior of the housing 120 into two regions. An air supply nozzle 131 is formed to pass through the lower surface of the housing 120, with the air supply nozzle 131 being in fluid communication with the air supply chamber 121. The air supply nozzle may be configured to spray the hot air in the width direction of the electrode plate 10. An exhaust nozzle 132 is formed to pass through the lower surface of the housing 120, with the exhaust nozzle 132 being in fluid communication with the exhaust chamber 122 and being configured to suck gas that has been used to dry the slurry 12. In other words, the housing 120 may have a hollow interior that is divided into the air supply chamber 121 and the exhaust chamber 122. The air supply chamber 121 may be positioned downstream (forward) with respect to the moving direction D of the electrode plate 10, and the exhaust chamber 122 may be positioned upstream (backward) with respect to the moving direction D of the electrode plate 10.

The air supply nozzle 131 may be formed to pass through the lower surface of the housing 120 and may be in fluid communication with the air supply chamber 121 so that the hot air supplied to the air supply chamber 121 may be sprayed towards the slurry 12. Because the air supply nozzle 131 is connected to the air supply chamber 121, the air supply nozzle 131 may be positioned downstream with respect to the moving direction D of the electrode plate 10.

The exhaust nozzle 132 may be formed to pass through the lower surface of the housing 120 and may be in fluid communication with the exhaust chamber 122 so that the gas flowing backward after drying the slurry 12 may be sucked into the exhaust chamber 122. Because the exhaust nozzle 132 is connected to the exhaust chamber 122, the exhaust nozzle 132 may be positioned downstream (backward) with respect to the moving direction D of the electrode plate 10. Thus, the air supply nozzle 131 may be positioned downstream (forward) with respect to the moving direction D of the electrode plate 10, and the exhaust nozzle 132 may be positioned upstream (backward) with respect to the moving direction D of the electrode plate 10 so as to face the air supply nozzle 131.

The air supply nozzle 131 and the exhaust nozzle 132 may be formed in an elongated slit shape along the width direction of the electrode plate 10. The air supply nozzle 131 and the exhaust nozzle 132 may be formed to be longer than the width of the electrode plate 10 so as to uniformly supply the hot air in the width direction of the slurry 12 and then recover the gas that has been used to dry the slurry 12 on the substrate 11. Accordingly, the hot air may be uniformly supplied in the width direction of the electrode plate 10 through the air supply nozzle 131, and the gas having dried the slurry 12 may be uniformly sucked in the width direction of the electrode plate 10 through the exhaust nozzle 132. Thus, the slurry 12 may be uniformly dried in the width direction of the electrode plate 10. As such, it is possible to prevent the slurry 12 from being overdried at ends of the electrode plate 10.

Referring to FIG. 3, the air supply nozzle 131 may be formed to be inclined at an acute angle θ1 with respect to the moving direction D of the electrode plate. In this configuration, the air supply nozzle 131 may supply the hot air in a direction that is at an angle and opposite to the moving direction D of the electrode plate. The exhaust nozzle 132 may be formed at an obtuse angle θ2 with respect to the moving direction D of the electrode plate. In this configuration, the exhaust nozzle 132 may suck the gas that has been supplied in the direction opposite to the moving direction D of the electrode plate and dried the slurry.

The drying part 110 may include an air supply connection part 141 that protrudes from the upper surface of the housing 120. The air supply connection part 141 may be joined to the air supply part 150 and be in fluid communication with the air supply chamber 121. The drying part 110 may also include an exhaust connection part 142 that protrudes from the upper surface of the housing 120. The exhaust connection part 142 may be joined to the exhaust part 160 and be in fluid communication with the exhaust chamber 122.

The air supply part 150 may include a hot air generation part 152 that generates hot air and an air supply duct 151 that connects the hot air generation part 152 and the air supply connection part 141. As such, in some embodiments the air supply connection part 141 and the hot air generation part 152 are connected by the air supply duct 151 so that the hot air is supplied from the hot air generation part 15 to the air supply chamber 121 through the air supply duct 151 and the air supply connection part 141.

The exhaust part 160 may include an exhaust duct 161 that is connected to the exhaust connection part 142 and into which gas that has been used to dry the slurry 12 is introduced. A gas exhaust part 162 may be connected to the exhaust duct 161 to discharge the used gas to outside of the apparatus. As such, in some embodiments the exhaust connection part 142 and the gas exhaust part 162 are connected by the exhaust duct 161 and the gas exhaust part 162 operates to force the gas introduced into the exhaust chamber 122 to move through the exhaust connection part 142 and the exhaust 161 to be discharged to outside of the apparatus. In some embodiments, a negative pressure is applied to the exhaust nozzle 132 to thereby make it easier to such the gas used to dry the slurry. The gas exhaust part 162 include a device such as a pneumatic pump or a fan that is capable of providing a force to discharge the used gas to outside of the apparatus.

Referring to FIG. 1, a plurality of drying parts 110 may be provided along the moving direction D of the electrode plate 10. Because the drying parts 110 may uniformly dry the slurry in the width direction of the electrode plate 10, the drying parts 110 may be provided along the moving direction D of the electrode plate 10 so as to simultaneously dry a wider area of the electrode plate 10. The drying parts 110 may be connected to the air supply duct 151 and the exhaust duct 161 to suck the gas used to dry the slurry and discharge the used gas while being simultaneously supplied with gas (hot air) for further drying the electrode plate.

The apparatus 100 for drying an electrode may further include a chamber 101 in which the drying part 110 is accommodated and through which the electrode plate 10 passes. In some embodiments, the chamber 101 may be elongated along the moving direction D of the electrode plate 10 so that the moving electrode plate 10 may pass therethrough. The chamber 101 may provide a sealed space so that external foreign matter or air flow does not affect the drying of the slurry. In some embodiments, the interior of the chamber 101 may be under a vacuum.

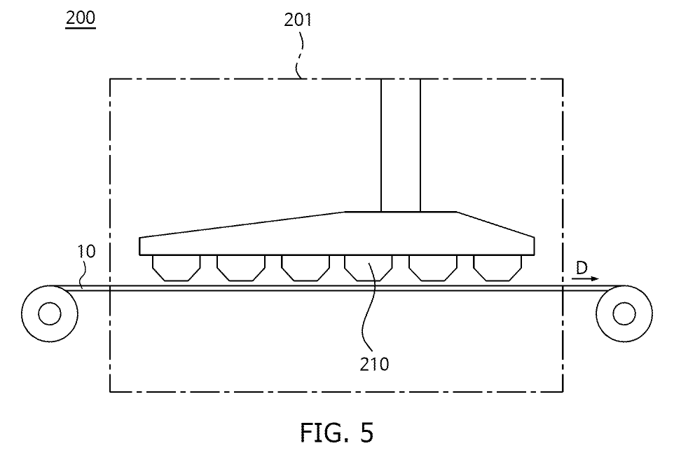

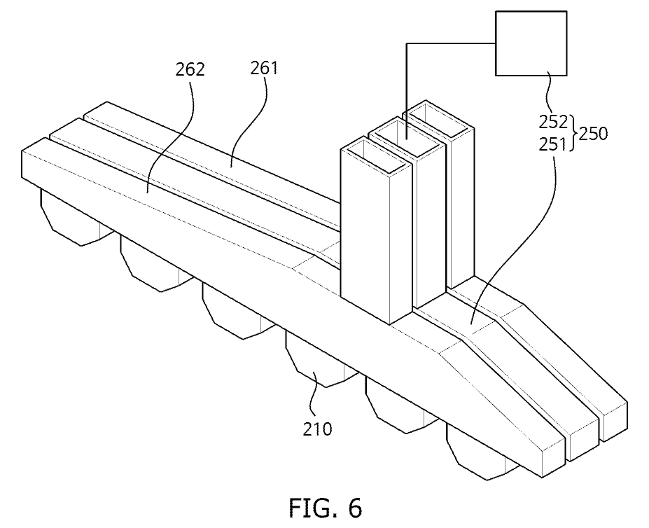

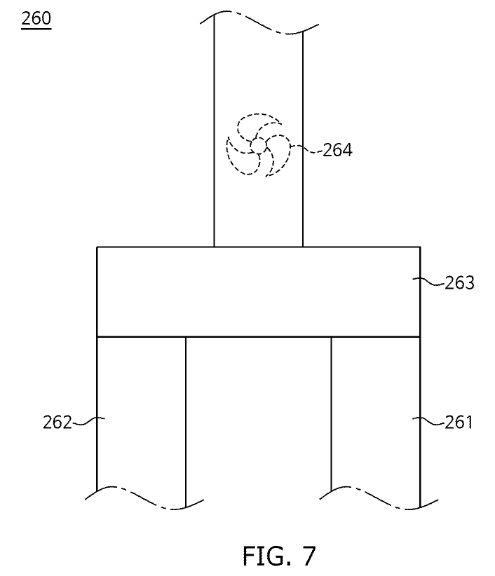

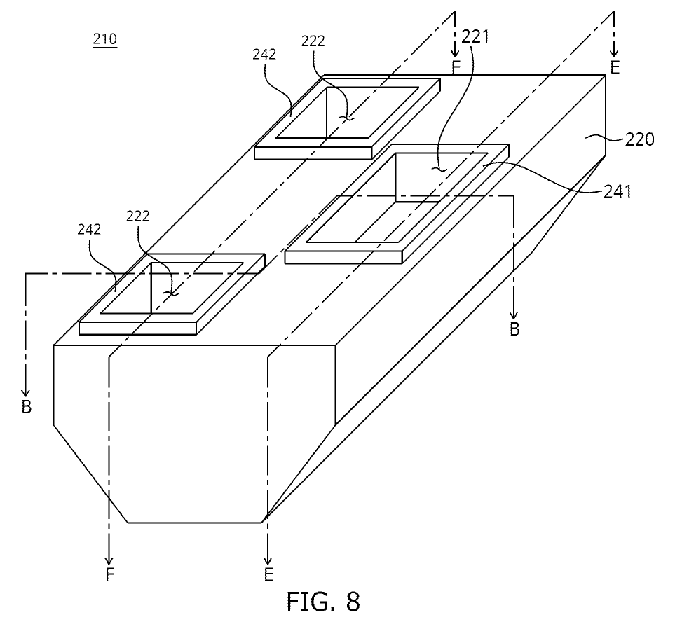

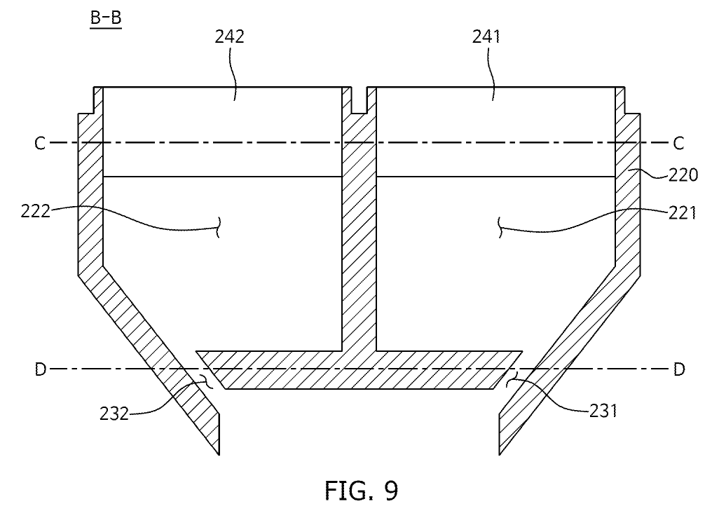

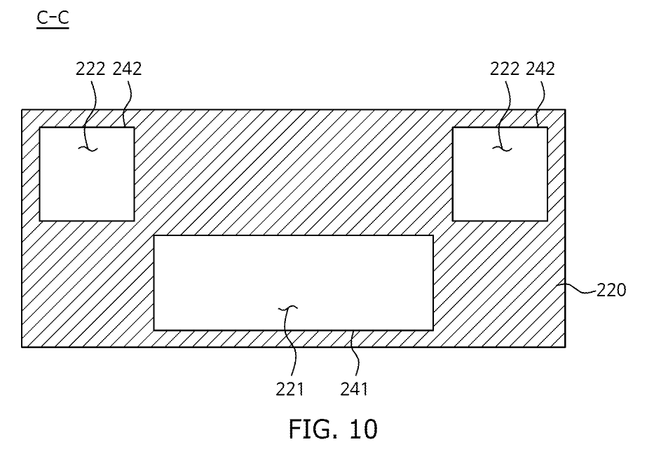

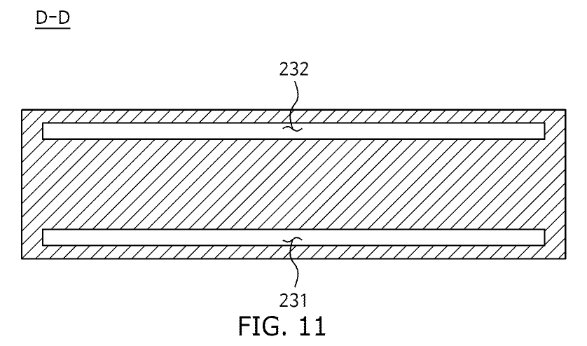

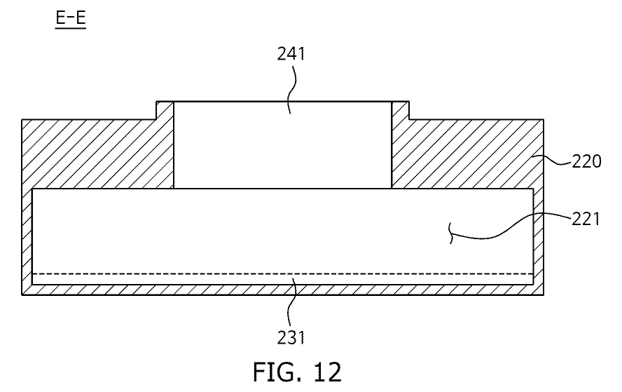

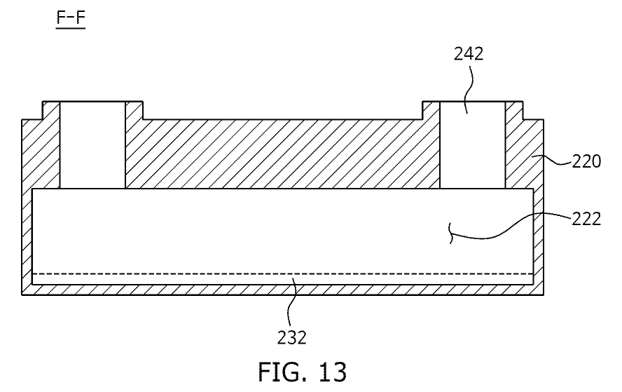

FIG. 5 is a side view of an apparatus for drying an electrode according to other embodiments of the present disclosure, FIG. 6 is a perspective view of the apparatus for drying an electrode according to other embodiments of the present disclosure, and FIG. 7 is a partial front view of an exhaust part in the apparatus for drying an electrode according to other embodiments of the present disclosure. FIG. 8 is a perspective view showing an example of a drying part in the apparatus for drying an electrode according to other embodiments of the present disclosure, FIG. 9 is a cross-sectional view showing an example of region B-B of FIG. 8, FIG. 10 is a cross-sectional view showing an example of region C-C of FIG. 9, FIG. 11 is a cross-sectional view showing an example of region D-D of FIG. 9, FIG. 12 is a cross-sectional view showing an example of region E-E of FIGS. 8, and 13 is a cross-sectional view showing an example of region F-F of FIG. 8.

Referring to FIGS. 5 to 13, an apparatus 200 for drying an electrode according to other embodiments of the present disclosure may include a drying part 210 thatdirects gas (hot air) to a moving electrode plate 10 to dry a slurry 12 applied onto a substrate 11, an air supply part 250 that supplies the hot air to the drying part 210, and an exhaust part 160 that discharges gas suck back into the drying part 210 to outside of the apparatus 200.

The drying part 210 may be positioned above the moving electrode plate 10 and may spray the hot air in a direction opposite to the moving direction D of the electrode plate 10 so as to dry the slurry 12 that has been applied onto the substrate 11. The drying part 210 may suck the gas that has been used to dry the slurry 12 and discharge the used gas to outside of the apparatus 200. That is, the drying part 210 may be configured to suck the gas used to dry the slurry 12 while spraying the hot air to the moving electrode plate 10 to further dry the slurry 12.

In some embodiments, the drying part 110 may include a housing 220 positioned above the electrode plate 10. The housing 220 may include an air supply chamber 221 and an exhaust chamber 222 formed by dividing the interior of the housing 220 into two regions. An air supply nozzle 231 is provided that passes through the lower surface of the housing 220 and is in fluid communication with the air supply chamber 221. The air supply nozzle 231 may be configured to spray the hot air in the width direction of the electrode plate 10. An exhaust nozzle 232 passes through the lower surface of the housing 220. The exhaust nozzle 232 is in fluid communication with the exhaust chamber 222 and is configured to suck gas that has dried the slurry 12.

The housing 220 may have a hollow interior that is divided into two regions to form the air supply chamber 221 and the exhaust chamber 222. The air supply chamber 221 may be positioned downstream (forward) with respect to the moving direction D of the electrode plate 10, and the exhaust chamber 222 may be positioned upstream (backward) with respect to the moving direction D of the electrode plate 10.

The air supply nozzle 231 may be formed to pass through the lower surface of the housing 220 and be in fluid communication with the air supply chamber 221 so that the hot air supplied to the air supply chamber 221 may be directed towards the slurry 12. Because the air supply nozzle 231 is connected to the air supply chamber 221, the air supply nozzle 231 may be positioned downstream (forward) with respect to the moving direction D of the electrode plate 10.

The exhaust nozzle 232 may be formed to pass through the lower surface of the housing 220 and be in fluid communication with the exhaust chamber 222. As such, the exhaust nozzle 232 may suck the gas flowing backward after drying the slurry 12. Because the exhaust nozzle 232 is connected to the exhaust chamber 222, the exhaust nozzle 232 may be positioned upstream (backward) with respect to the moving direction D of the electrode plate 10. Accordingly, the air supply nozzle 231 may be positioned downstream (forward) with respect to the moving direction D of the electrode plate 10, and the exhaust nozzle 232 may be positioned upstream (backward) with respect to the moving direction D of the electrode plate 10 so as to face the air supply nozzle 231.

Referring to FIG. 11, the air supply nozzle 231 and the exhaust nozzle 232 may be formed in elongated slit shapes along the width direction of the electrode plate 10. The air supply nozzle 231 and the exhaust nozzle 232 may be longer than the width of the electrode plate 10 so as to uniformly supply and recover the hot air in the width direction of the slurry 12. That is, the hot air may be uniformly supplied in the width direction of the electrode plate 10 through the air supply nozzle 231, and the gas that has been used to dry the slurry 12 may be uniformly sucked in the width direction of the electrode plate 10 through the exhaust nozzle 232. Thus, the slurry 12 may be uniformly dried in the width direction of the electrode plate 10. It is thereby possible to prevent the slurry 12 from being overdried at ends of the electrode plate 10.

The air supply nozzle 231 may be inclined at an acute angle with respect to the moving direction D of the electrode plate 10, and the exhaust nozzle 232 may be inclined at an obtuse angle with respect to the moving direction D of the electrode plate 10. In such a configuration, the air supply nozzle 231 may supply the hot air at a sloped angle in a direction opposite to the moving direction D of the electrode plate 10 and the exhaust nozzle 232 may be configured to easily suck the hot air used to dry the slurry 12 in a direction opposite to the moving direction D of the electrode plate 10.

The drying part 210 may include an air supply connection part 241 that protrudes from the upper surface of the housing 220. The air supply connection part 41 is joined to an air supply part 250 and in fluid communication with the air supply chamber 221. An exhaust connection part 242 protrudes from the upper surface of the housing 220. The exhaust connection part 242 is joined to an exhaust part 260 and is in fluid communication with the exhaust chamber 222.

Referring to FIG. 8, the air supply connection part 241 may protrude from the central portion of the upper surface of the housing 220. The air supply connection part 241 extend to the air supply chamber 221. That is, the air supply connection part 241 may have one end protruding from the upper surface of the housing 220 and the other end positioned in the air supply chamber 221.

The exhaust connection part 242 may protrude from opposite ends of the upper surface of the housing 220. The exhaust connection parts 242 are formed in a pair and may be formed at opposite ends in the width direction of the housing 220. The exhaust connection part 242 may extend to the exhaust chamber 222. That is, the exhaust connection part 242 may have one end protruding from the upper surface of the housing 220 and the other end positioned in the exhaust chamber 222.

Referring to FIG. 10, the width of the air supply connection part 241 may be less than the width of the air supply chamber 221, and the width of the exhaust connection part 242 may be less than the width of the exhaust chamber 222. The air supply connection part 241 and the exhaust connection part 242 may be formed so as not to overlap each other in the moving direction of the electrode plate 10. That is, based on the width direction of the housing 220, the exhaust connection parts 242 may be formed at opposite ends and the air supply connection part 241 may be formed at a distance from the exhaust connection part 242. But the present disclosure is not limited to such a configuration, and the air supply connection part 241 and the exhaust connection part 242 may be formed so that at least one area of the parts 241 and 242 overlaps in the moving direction of the electrode plate 10.

The width of the air supply connection part 241 may larger than the width of the exhaust connection part 242. Because the hot air must be supplied through the air supply connection part 241, the air supply connection part 241 may be relatively larger than the exhaust connection part 242. .But the present disclosure is not limited thereto, and the widths of the exhaust connection parts 242 may be equal to or similar to the width of the air supply connection part 241. In some embodiments, the size obtained by adding the widths of the exhaust connection parts 242 is larger than the width of the air supply connection part 241.

Referring to FIG. 12, the width of the air supply chamber 221 may be formed to correspond to the width of the air supply nozzle 231. With this configuration, the air supply connection part 241 has a relatively small width, thus, the hot air may be supplied to the air supply nozzle 231 while expanding in the width direction in the air supply chamber 221. As such, the hot air may be discharged from the air supply nozzle 231 at a relatively high flow rate in the central portion and at a relatively low flow rate at ends in the width direction.

Referring to FIG. 13, the width of the exhaust chamber 222 may be formed to correspond to the width of the exhaust nozzle 232. With this configuration, a suction force is provided through the exhaust connection part 242 having a relatively small width and gas entering the exhaust chamber 222 is moved to ends in the width direction and a negative pressure is applied to the exhaust nozzle 232 to aid in gas suction. The gas may be sucked at a relatively high flow rate at ends and at a relatively low flow rate in the central portion in the width direction.

The air supply part 250 may include a hot air generation part 252 that generates hot air, and an air supply duct 251 that connects the hot air generation part 252 and the air supply connection part 241. That is, the air supply connection part 241 and the hot air generation part 252 are connected by the air supply duct 251 and the hot air is supplied from the hot air generation part 252 to the air supply chamber 221 through the air supply duct 251 and the air supply connection part 241.

The exhaust part 260 may include an exhaust duct that is connected to the exhaust connection part 242 and through which gas used to dry the slurry 12 flows. The exhaust part 260 may also include a gas exhaust part 264 connected to the exhaust duct. The gas exhaust part 264 may be a device such as a pneumatic pump or a fan that is capable of forcing gas to be discharged to outside of the apparatus.

In some embodiments, the exhaust duct may include a first exhaust duct 261 connected to the exhaust connection part 242 formed at a first end of the housing 220 and a second exhaust duct 262 connected to the exhaust connection part 242 formed at a second end of the housing 220. An exhaust duct connection part 263 connects the first exhaust duct 261 and the second exhaust duct 262. The fan-shaped gas exhaust part 264 may be provided in the exhaust duct connection part 263 so that the gas inside the first exhaust duct 261 and the second exhaust duct 262 is discharged to outside of the apparatus.

The air supply connection part 241 is formed in the central portion of the housing 220 and the pair of exhaust connection parts 242 are formed at ends of the housing 220. Accordingly, as shown in FIG. 6, the first exhaust duct 261 and the second exhaust duct 262 are positioned at opposite sides of the air supply duct 251, which is positioned between the first exhaust duct 261 and the second exhaust duct 262. But the arrangement of the air supply duct 251, the first exhaust duct 261, and the second exhaust duct 262 is not limited to the depicted embodiment and may be configured in any shape as long as the air supply duct 251, the first exhaust duct 261, and the second exhaust duct 262 are connected to the air supply connection part 241 and the pair of exhaust connection parts 242.

Referring to FIG. 5, a plurality of drying parts 210 may be provided along the moving direction D of the electrode plate 10. Because the drying part 210 may uniformly dry the slurry in the width direction of the electrode plate 10, the drying parts 210 may be provided along the moving direction D of the electrode plate 10 so as to simultaneously dry a wide area.

The apparatus 200 for drying an electrode may further include a chamber 201 in which the drying part 210 is accommodated and through which the electrode plate 10 passes. In some embodiments, the chamber 201 may be elongated along the moving direction D of the electrode plate 10 so that the moving electrode plate 10pass therethrough during the drying process. The chamber 201 may provide a sealed space so that external foreign matter or air flow does not affect the drying of the slurry. In some embodiments, the interior of the chamber 201 may be in a vacuum state. Referring to FIG. 6, the drying parts 210 may be connected to the air supply duct 251 and the exhaust ducts 261 and 262 to suck the gas that has been used to dry the slurry and discharge the gas to outside at the same time that hot air is supplied to dry the electrode.

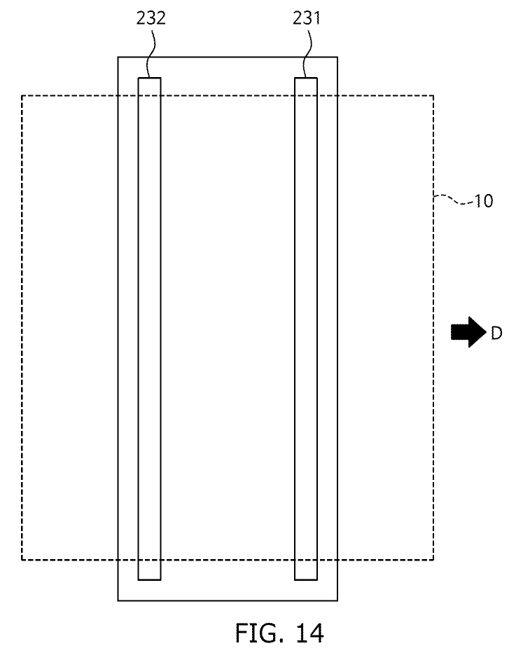

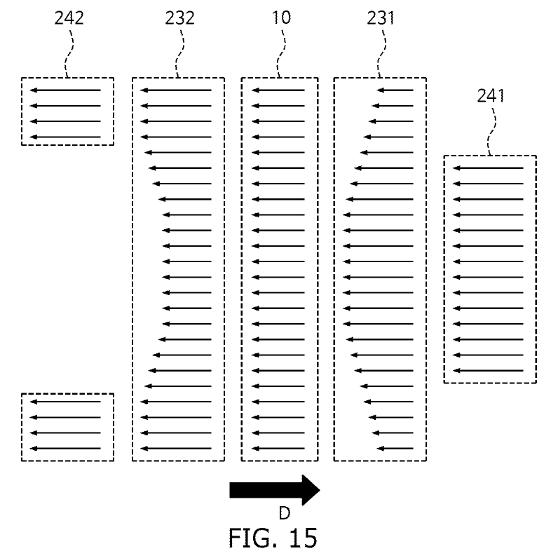

FIG. 14 is a bottom view of the drying part positioned above the electrode according to other embodiments of the present disclosure, and FIG. 15 illustrates an example of a state in which gas flows through the drying part according to other embodiments of the present disclosure.

Referring to FIGS. 14 and 15, the air supply nozzle 231 and the exhaust nozzle 232 may be formed in an elongated slit shape along the width direction of the electrode plate 10 and may be formed to be longer than the width of the electrode plate 10 so as to be positioned to protrude outward from opposite ends of the electrode plate 10. With this configuration and arrangement, by sucking the gas that has been used to dry the slurry while supplying gas (hot air) to the entire area in the width direction of the electrode plate 10, it is possible to ensure uniform drying of the slurry in the width direction of the electrode plate 10.

The flow of the gas that dries the slurry through the drying part 210 described with reference to FIG. 8 is shown in FIG. 15. Referring to FIG. 15, in some embodiments, hot air at a uniform speed is supplied to the central portion from the air supply connection part 241. The hot air may be sprayed at a slower speed from the central portion to the ends of the air supply nozzle 231 formed with a wider width than the air supply connection part 241.

In some embodiments, gas is sucked at a uniform speed through the pair of exhaust connection parts 242 positioned at ends of the electrode plate 10. The gas may be sucked at a higher flow rate from the central portion to opposite ends through the exhaust nozzle 232 formed with a wider width than the exhaust connection parts 242.

Due to the difference between the relative speed of the hot air sprayed from the air supply nozzle 231 and the relative speed of the gas sucked from the exhaust nozzle 232, the flow rate of the hot air flowing through the upper portion of the electrode plate 10 may be the same or similar along the width direction. Thus, the slurry may be uniformly dried in the width direction of the electrode plate 10.

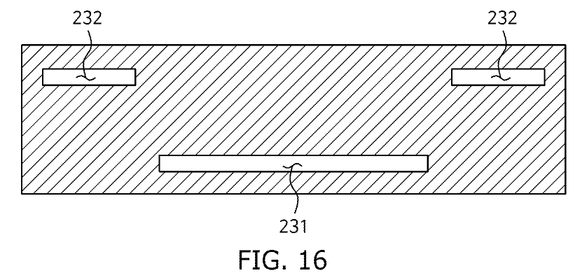

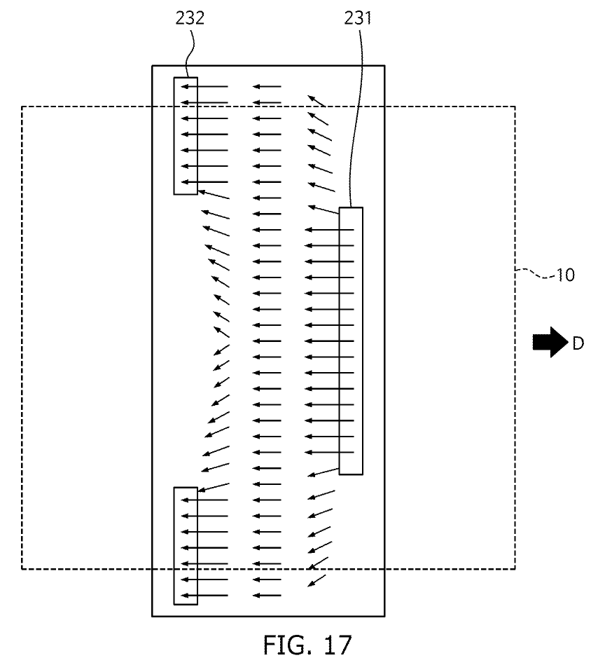

FIG. 16 illustrates another example of a nozzle in a drying part according to other embodiments of the present disclosure, and FIG. 17 illustrates an example of a state in which gas flows through the nozzle of FIG. 16.

Referring to FIGS. 16 and 17, the width of an air supply nozzle 231 and the width of an exhaust nozzle 232 may be equal to the width of the air supply connection part 241 and the width of the exhaust connection part 242 shown in FIG. 10. With this configuration, an air supply chamber may be formed with the same width as the air supply nozzle 231 and the air supply connection part 241, and the exhaust chamber may be formed with the same width as the exhaust nozzle 232 and the exhaust connection part 242. As such, hot air is sprayed from the air supply nozzle 231 to the central portion at a uniform speed, the hot air may be supplied to the electrode plate 10 with the speed becoming slower toward ends in the width direction.

In some embodiments, gas is sucked at a uniform speed from a pair of exhaust nozzles 232 positioned at ends of the electrode plate 10, and the gas may be sucked in at a higher flow rate from the central portion to opposite ends. Due to the difference between the relative speed of the hot air from the air supply nozzle 231 and the relative speed of the gas discharged through the exhaust nozzle 232, the flow rate of the hot air flowing through the upper portion of the electrode plate 10 may be the same or similar along the width direction of the electrode plate 10. In this manner, the slurry may be dried uniformly in the width direction of the electrode plate 10.

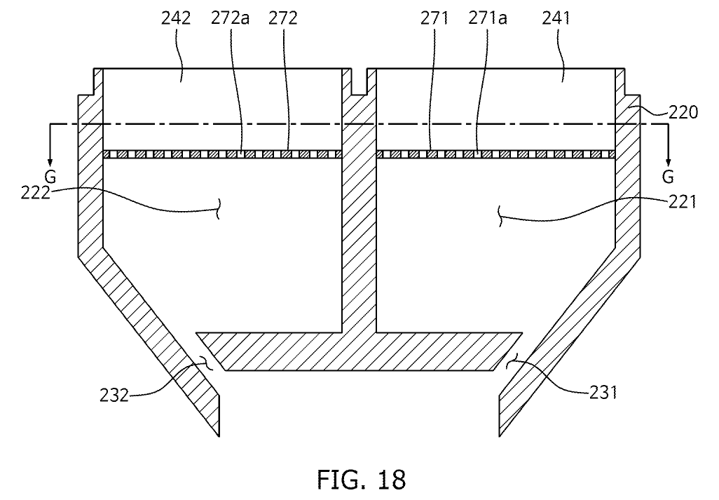

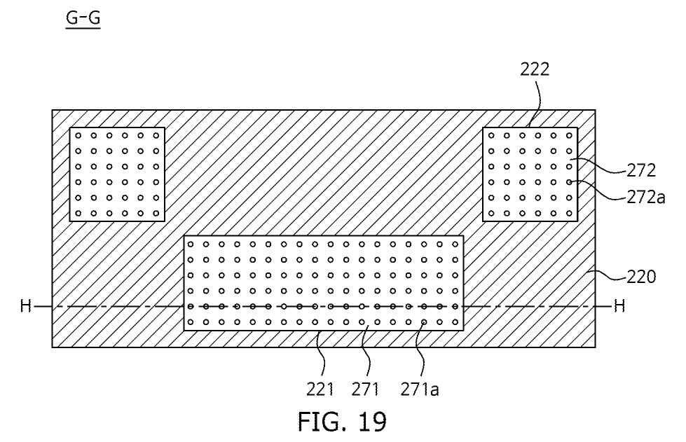

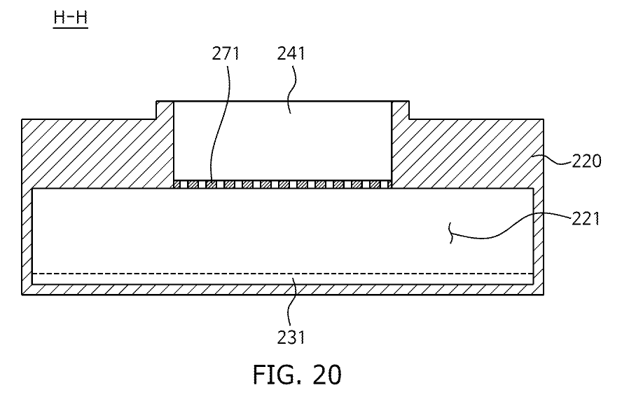

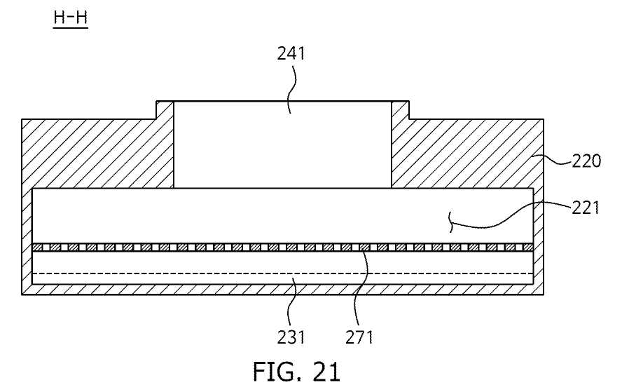

FIG. 18 is a cross-sectional view showing an example of a drying part having a perforation plate according to other embodiments of the present disclosure, FIG. 19 illustrates a cross-sectional view showing an example of region G-G of FIG. 18, and FIGS. 20 and 21 illustrate cross-sectional views showing an example of an air supply perforation plate positioned by cutting region H-H of FIG. 19.

Referring to FIGS. 18 and 19, the drying part 210 may further include an air supply perforation plate 271 having a plurality of through holes 271a through which supplied hot air flows. The drying part 210 may also include an exhaust perforation plate 272 having a plurality of through holes 272a through which gas can be discharged after drying the slurry. In the embodiment shown in FIG. 18, both the air supply perforation plate 271 and the exhaust perforation plate 272 are provided. But the present disclosure is not limited thereto, and only one of the air supply perforation plate 271 and the exhaust perforation plate 272 may be provided in some embodiments.

Referring to FIG. 20, the air supply perforation plate 271 may be provided at the end of the air supply connection part 241. That is, the air supply perforation plate 271 may be provided at a portion of the air supply connection part 241 connected to the air supply chamber 221. With this configuration, hot air supplied to the air supply connection part 241 may be supplied to the air supply chamber 221 with the flow rate and flow velocity being made uniform while passing through the through holes 271a formed in the air supply perforation plate 271. In this manner, the hot air discharged from the air supply nozzle 231 may be uniformly in the width direction. Although not shown, the exhaust perforation plate 272 may also be provided at a portion of the exhaust chamber 222 connected to the exhaust connection part 242.

Referring to FIG. 21, the air supply perforation plate 271 may also be provided inside the air supply chamber 221. With this configuration, hot air supplied to the air supply connection part 241 through the air supply connection part 241 may be supplied to the air supply nozzle 231 with the flow rate and flow velocity made uniform while passing through the through holes 271a formed in the air supply perforation plate 271. In this manner, the hot air discharged from the air supply nozzle 231 may be uniform in the width direction. Although not shown, the exhaust perforation plate 272 may also be provided in the exhaust chamber 222.

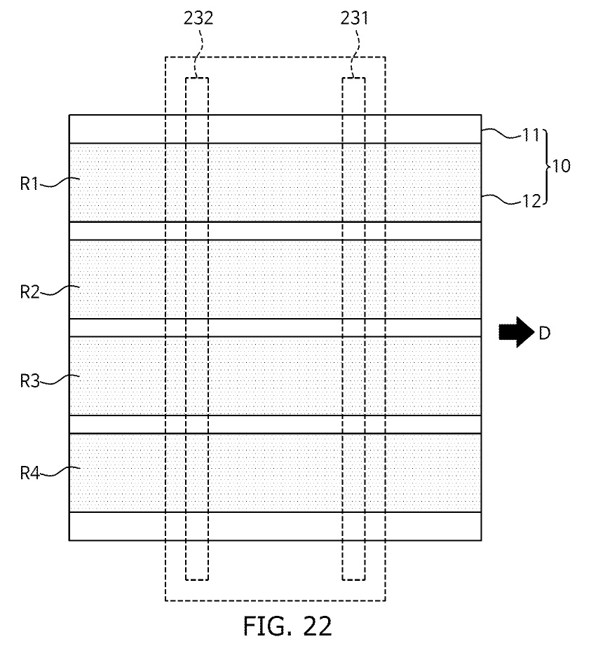

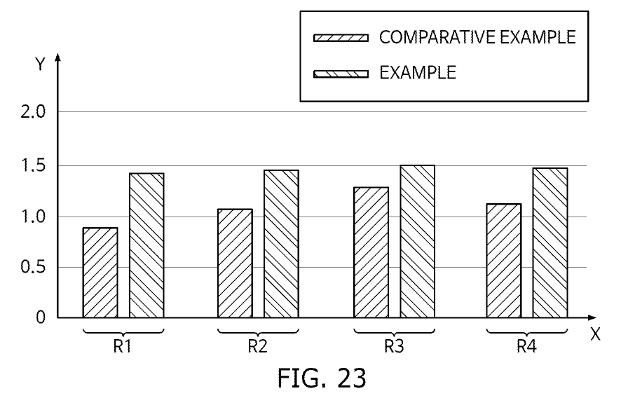

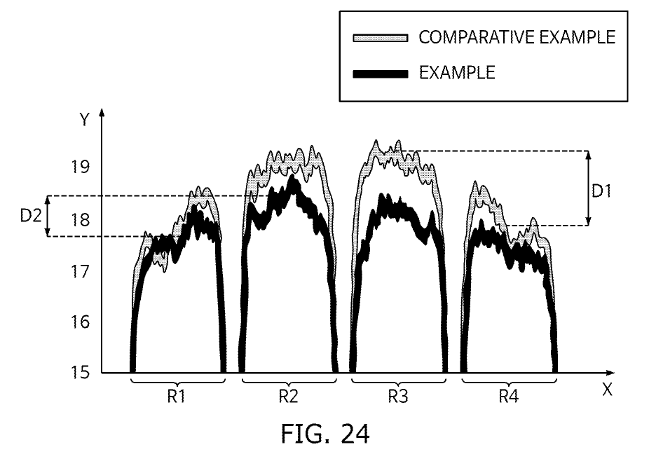

FIG. 22 is a plan view showing an example in which the drying part dries four rows of slurry formed on a substrate according to other embodiments of the present disclosure, FIG. 23 is a graph comparing the adhesive strength of four rows of slurry layers dried by the drying part according to other embodiments of the present disclosure, and FIG. 24 is a graph comparing the density of four rows of slurry layers dried by the drying part according to other embodiments of the present disclosure.

Referring to FIGS. 22 to 24, an electrode plate 10 having four rows of slurry 12 formed on a substrate 11 was dried by using the drying part according to other embodiments of the present disclosure, and the adhesive strength and density of the slurry layers were compared.

Referring to FIG. 22, the slurry may be formed in a first row R1, a second row R2, a third row R3, and a fourth row R4, with the rows R1-R4 being spaced at intervals along the width direction of the substrate 11. The air supply nozzle 231 and the exhaust nozzle 232 may be formed so that their lengths in the width direction are greater than the width of the electrode plate 10. That is, opposite ends of the air supply nozzle 231 and the exhaust nozzle 232 may be positioned outward of the first row R1 and the fourth row R4.

FIG. 23 is a graph comparing the adhesive strength of the slurry layer dried by the apparatus for drying an electrode according to embodiments of the present disclosure (Example) and the adhesive strength of the electrode plate without using the apparatus for drying an electrode (Comparative Example). In the graph, the X-axis represents the width direction of the plate and the Y-axis represents the adhesive strength (gf/mm).

Referring to FIG. 23, it can be seen that the adhesive strength of the Example in the first to fourth rows R1 to R4 is greater than the adhesive strength in the corresponding rows of the Comparative Example. That is, it can be seen that the adhesive strength of the slurry layer dried by using the apparatus for drying an electrode according to embodiments of the present disclosure is superior to the adhesive strength of the slurry layer dried without using the apparatus for drying an electrode.

In the Comparative Example, it can be seen that the adhesive strength of the third row R3, which is the central portion of the electrode plate, is the highest, the adhesive strengths of the second row R2 and the fourth row R4 are the second highest, and the adhesive strength of the first row R1, which is the edge, is low. Thus, in the Comparative Example the adhesive strength of the slurry layer is non-uniform along the width direction of the electrode plate. In comparison, in the Example according to embodiments of the present disclosure, the adhesive strengths of the first to fourth rows R1 to R4 are uniformly high.

FIG. 24 is a graph comparing the density of the slurry layer dried by the apparatus for drying an electrode according to embodiments of the present disclosure (Example) and the density of the electrode plate dried without using the apparatus for drying an electrode (Comparative Example). In the graph, the X-axis represents the width direction of the electrode plate and the Y-axis represents the density (mg/cm²). The density is the mass (loading level) of the active material per unit area.

Referring to FIG. 24, in the Comparative Example, a difference D1 between the average density of the second row R2 and the third row R3 and the average density of the first row R1 and the fourth row R4 is approximately 1.6 mg/cm², which is relatively high. In comparison, in the Example, a difference D2 between the average density of the second row R2 and the third row R3 and the average density of the first row R1 and the fourth row R4 is approximately 0.8 mg/cm², which is relatively low. Thus, in the Comparative Example, there is a large difference in density between the central portion and opposite ends of the electrode plate, and over drying may occur at the ends with lower density, which may cause greater non-uniform drying of the slurry in the width direction. In comparison, because the density difference between the central portion and the ends of the electrode plate is not large in the Example according to embodiments of the present disclosure, the entire electrode plate may be uniformly dried.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF SOME REFERENCE SYMBOLS

100, 200: apparatus for drying electrode

110, 210: drying part

120, 220: housing

121, 221: air supply chamber

122, 222: exhaust chamber

131, 231: air supply nozzle

132, 232: exhaust nozzle

141, 241: air supply connection part

142, 242: exhaust connection part

150, 250: air supply part

160, 260: exhaust part

What is claimed is:

1. An apparatus for drying an electrode, the apparatus comprising:
a drying part configured (i) to be positioned above a moving electrode plate, (ii) to direct a gas in a direction opposite to a moving direction of the electrode plate to dry a slurry formed on a substrate of the electrode plate, and (iii) to suck gas that has been used to dry the slurry;
a gas supply part configured to supply the gas to the drying part; and
an exhaust part configured to discharge the gas sucked into the drying part to outside of the apparatus.

2. The apparatus as claimed in claim 1, wherein the drying part comprises:
a housing positioned above the electrode plate and comprising an gas supply chamber and an exhaust chamber;
a gas supply nozzle passing through a lower surface of the housing, in fluid communication with the gas supply chamber, and configured to direct the gas in a width direction of the electrode plate; and
an exhaust nozzle passing through the lower surface of the housing, in fluid communication with the exhaust chamber, and configured to suck in gas that has been used to dry the slurry.

3. The apparatus as claimed in claim 2, wherein the gas supply nozzle is positioned downstream with respect to the moving direction of the electrode plate, and
wherein the exhaust nozzle is positioned upstream with respect to the moving direction of the electrode plate and facing the gas supply nozzle.

4. The apparatus as claimed in claim 2, wherein the gas supply nozzle and the exhaust nozzle are formed in an elongated slit shape along a width direction of the electrode plate and are longer than a width of the electrode plate.

5. The apparatus as claimed in claim 2, wherein the gas supply nozzle is positioned at an acute angle with respect to the moving direction of the electrode plate.

6. The apparatus as claimed in claim 2, wherein the exhaust nozzle is positioned at an obtuse angle with respect to the moving direction of the electrode plate.

7. The apparatus as claimed in claim 2, wherein the drying part comprises:
a gas supply connection part protruding from an upper surface of the housing, with the gas supply connection part being joined to the gas supply part and in fluid communication with the gas supply chamber; and
an exhaust connection part protruding from the upper surface of the housing, with the exhaust connection part being joined to the exhaust part and in fluid communication with the exhaust chamber.

8. The apparatus as claimed in claim 7, wherein the gas supply connection part protrudes from the upper surface of the housing in a central portion of the housing and has a width that is less than a width of the gas supply chamber.

9. The apparatus as claimed in claim 8, wherein the exhaust connection part is configured protrudes from ends of the housing and has a width that is less than a width of the exhaust chamber.

10. The apparatus as claimed in claim 9, wherein the gas supply connection part and the exhaust connection part do not overlap each other in the moving direction of the electrode plate.

11. The apparatus as claimed in claim 9, wherein the width of the gas supply connection part is greater than the width of the exhaust connection part.

12. The apparatus as claimed in claim 8, wherein a width of the gas supply nozzle is equal to the width of the gas supply connection part.

13. The apparatus as claimed in claim 9, wherein a width of the exhaust nozzle is equal to the width of the exhaust connection part.

14. The apparatus as claimed in claim 7, wherein the drying part further comprises a gas supply perforation plate provided in at least one of the gas supply connection part and the gas supply chamber, the gas supply perforation plate having a plurality of through holes through which the gas can flow.

15. The apparatus as claimed in claim 7, wherein the drying part further comprises a gas supply perforation plate provided in at least one of the exhaust connection part and the exhaust chamber, the gas supply perforation plate having a plurality of through holes through which the gas used to dry the slurry can flow.

16. The apparatus as claimed in claim 9, wherein the gas supply part comprises:
a gas generation part configured to generate the gas; and
an exhaust duct configured to connect the gas generation part and the gas supply connection part, the exhaust duct being configured to supply the gas.

17. The apparatus as claimed in claim 16, wherein the exhaust part comprises:
an exhaust duct connected to the exhaust connection part and into which the gas used to dry the slurry can be introduced; and
a gas exhaust part connected to the exhaust duct and configured to force gas to be discharged to outside of the apparatus.

18. The apparatus as claimed in claim 17, wherein the exhaust duct comprises:
a first exhaust duct connected to an exhaust connection part formed at a first end of the housing; and
a second exhaust duct connected to an exhaust connection part formed at a second end of the housing.

19. The apparatus as claimed in claim 18, wherein the exhaust duct further comprises an exhaust duct connection part configured to connect the first exhaust duct and the second exhaust duct.

20. The apparatus as claimed in claim 1, wherein the drying part is provided in plurality along the moving direction of the electrode plate.
